(19) United States
(12) Patent Application Publication
(10) Pub. No.: US 2020/0131343 A1
(43) Pub. Date: Apr. 30, 2020

(54) RUBBER COMPOSITION FOR CONVEYOR BELT AND CONVEYOR BELT

(71) Applicant: THE YOKOHAMA RUBBER CO., LTD., Tokyo (JP)

(72) Inventor: Deqing ZOU, Hiratsuka City (JP)

(73) Assignee: The Yokohama Rubber Co., LTD., Tokyo (JP)

(21) Appl. No.: 16/493,199

(22) PCT Filed: Dec. 27, 2017
(86) PCT No.: PCT/JP2017/047024

§ 371 Date: Sep. 11, 2019

(30) Foreign Application Priority Data
Mar. 14, 2017 (JP) 2017-048763

(51) Int. Cl. C08L 7/00; B65G 15/32

(52) U.S. Cl. CPC C08L 7/00; B65G 15/32

(57) ABSTRACT

A rubber composition for a conveyor belt includes: a rubber component containing from 80 to 100% by mass of a natural rubber and from 0 to 20% by mass of a butadiene rubber; carbon black; sulfur; and a vulcanization accelerator, in which a content of the carbon black is from 45 to 100 parts by mass with respect to 100 parts by mass of the rubber component, a content of the sulfur is from 0.50 to 2.00 parts by mass with respect to 100 parts by mass of the rubber component, a content of the vulcanization accelerator is 1.50 parts by mass or less with respect to 100 parts by mass of the rubber component, and a mass ratio of the vulcanization accelerator to the sulfur is from 0.50 to 3.00. A conveyor belt includes an upper surface cover rubber layer formed of the rubber composition for a conveyor belt.

### TECHNICAL FIELD

The present invention relates to a rubber composition for a conveyor belt and a conveyor belt.

### BACKGROUND ART

In recent years, a conveyor belt having a long life is required from the viewpoint of considering the environment. Regarding such a problem, a rubber composition for improving a wear resistance life of a belt conveyor has been proposed in the related art. For example, Patent Document 1 discloses a rubber composition for a belt of a belt conveyor containing a polybutadiene rubber synthesized by using a neodymium-based catalyst as a rubber component.

### CITATION LIST

### Patent Literature

Patent Document 1: JP 2003-105136 A

### SUMMARY OF INVENTION

### Technical Problem

In such circumstances, the present inventors have prepared a rubber composition with reference to Patent Document 1 and evaluated it, and as a result, the present inventors found that a wear resistance and an impact resistance of such a rubber composition may deteriorate.

Therefore, an object of the present invention is to provide a rubber composition for a conveyor belt having an excellent wear resistance and impact resistance and a conveyor belt.

### Solution to Problem

As a result of diligent research to solve the problem described above, the present inventors have found that in a case where a rubber component containing a natural rubber in a predetermined amount (further, the rubber component may contain a butadiene rubber in a predetermined range), carbon black, sulfur, and a vulcanization accelerator, each are included in a specific amount, and a mass ratio of the vulcanization accelerator to the sulfur is within a predetermined range, a desired effect can be obtained, thereby completing the present invention.

The present invention is based on the findings described above and, specifically, solves the problem described above by the following features.

1. A rubber composition for a conveyor belt containing: a rubber component containing from 80 to 100% by mass of a natural rubber and from 0 to 20% by mass of a butadiene rubber; carbon black; sulfur; and a vulcanization accelerator, in which a content of the carbon black is from 45 to 100 parts by mass with respect to 100 parts by mass of the rubber component, a content of the sulfur is from 0.50 to 2.00 parts by mass with respect to 100 parts by mass of the rubber component, a content of the vulcanization accelerator is 1.50 parts by mass or less with respect to 100 parts by mass of the rubber component, and a mass ratio of the vulcanization accelerator to the sulfur is from 0.50 to 3.00.

2. The rubber composition for a conveyor belt described in 1 above, in which a nitrogen adsorption specific surface area of the carbon black is from 115 to 160 m²/g, and a dibutyl phthalate oil absorption amount of the carbon black is from 115 to 140 mL/100 g.

3. The rubber composition for a conveyor belt described in 1 or 2 above, in which the rubber component contains a natural rubber and a butadiene rubber, a content of the natural rubber is more than 80% by mass and 95% by mass or less with respect to a total amount of the rubber component, and a content of the butadiene rubber is 5% by mass or more and less than 20% by mass with respect to the total amount of the rubber component.

4. The rubber composition for a conveyor belt described in any one of 1 to 3 above, in which a content of the carbon black is more than 50 parts by mass and 80 parts by mass or less with respect to 100 parts by mass of the rubber component.

5. The rubber composition for a conveyor belt described in any one of 1 to 4 above, in which a content of the sulfur is 0.50 parts by mass or more and less than 2.00 parts by mass with respect to 100 parts by mass of the rubber component.

6. A conveyor belt including: an upper surface cover rubber layer formed of the rubber composition for a conveyor belt described in any one of 1 to 5 above; a reinforcing layer; and a lower surface cover rubber layer.

### Advantageous Effects of Invention

The rubber composition for a conveyor belt of the present invention and the conveyor belt of the present invention are excellent in wear resistance and impact resistance.

### BRIEF DESCRIPTION OF DRAWING

FIG. 1 is a cross-sectional perspective view schematically illustrating an example of a conveyor belt according to a preferred embodiment of the present invention.

### DESCRIPTION OF EMBODIMENTS

The present invention is described in detail below.

Note that in the present specification, numerical ranges indicated using “(from) . . . to . . . ” include the former number as the lower limit value and the latter number as the upper limit value.

In the present specification, unless otherwise noted, a single corresponding substance may be used for each component, or a combination of two or more types of corresponding substances may be used for each component. When a component contains two or more types of substances, the content of the component means the total content of the two or more types of substances.

In the present specification, a case where any one of wear resistance or impact resistance is more excellent may be referred to as “effects of the present invention are more excellent”.

### Rubber Composition for Conveyor Belt

A rubber composition (a composition of the present invention) for a conveyor belt of the present invention, contains: a rubber component containing from 80 to 100% by mass of a natural rubber and from 0 to 20% by mass of a butadiene rubber; carbon black; sulfur; and a vulcanization accelerator, in which a content of the carbon black is from 45 to 100 parts by mass with respect to 100 parts by mass of the rubber component, a content of the sulfur is from 0.50 to 2.00 parts by mass with respect to 100 parts by mass of the rubber component, a content of the vulcanization accelerator is 1.50 parts by mass or less with respect to 100 parts by mass of the rubber component, and a mass ratio of the vulcanization accelerator to the sulfur is from 0.50 to 3.00.

The composition according to an embodiment of the present invention is thought to achieve desired effects as a result of having such a configuration. Although the reason is not clear, it is assumed approximately as follows.

The present inventors have found that in a case of a rubber composition containing a natural rubber and a butadiene rubber, wear resistance and/or impact resistance may deteriorate.

The present inventors have conceived that when a large amount of sulfur is used in a rubber composition containing at least a natural rubber, the crystallinity of the natural rubber (for example, extension crystallinity: a property that a molecular chain is oriented in an extension direction when extended, such that crystallization is obtained) may be impaired.

Further, the present inventors have found that in a case where, carbon black, sulfur, and a vulcanization accelerator, each are included in a specific amount with respect to a rubber component containing a natural rubber in a specific amount, and a mass ratio of the vulcanization accelerator to the sulfur is within a predetermined range, a wear resistance and an impact resistance are excellent.

Each of the components included in the composition according to an embodiment of the present invention will be described in detail below.

### Rubber Component

The composition of the present invention contains a rubber component and the rubber component contains a natural rubber. All of the rubber components may be a natural rubber. The rubber component containing butadiene rubber is further preferable from the viewpoint of more excellent effects of the present invention.

### Natural Rubber

The natural rubber included in the composition of the present invention is not particularly limited. Examples thereof include known products.

In the present invention, the content of the natural rubber is from 80 to 100% by mass with respect to the total amount of the rubber component.

The content of the natural rubber is preferably more than 80% by mass and 95% by mass or less, and more preferably from 85 to 95% by mass, with respect to the total amount of the rubber component, from the viewpoint of more excellent effects of the present invention.

### Butadiene Rubber

Butadiene rubber (BR) is a homopolymer of butadiene.

### Weight Average Molecular Weight of Butadiene Rubber

The weight average molecular weight of butadiene rubber is preferably from 500000 to 1000000 and more preferably from 500000 to 800000 from the viewpoint of more excellent effects (in particular, wear resistance) of the present invention and excellent workability.

In the present invention, the weight average molecular weight of the butadiene rubber is expressed in terms of standard polystyrene based on a value measured by gel permeation chromatography (GPC) using tetrahydrofuran (THF) as a solvent.

### Microstructure of Butadiene Rubber

The content of a 1,4-cis structure of butadiene rubber is preferably 97% or more and more preferably 98% or more from the viewpoint of more excellent effects (in particular, wear resistance) of the present invention.

The content of a 1,4-trans structure of butadiene rubber is preferably 1.5% or less and more preferably 1.0% or less from the viewpoint of more excellent effects (in particular, wear resistance) of the present invention.

The content of a 1,2-vinyl structure of butadiene rubber is preferably 1.5% or less and more preferably 1.0% or less from the viewpoint of more excellent effects (in particular, wear resistance) of the present invention.

In the present invention, the microstructure of the butadiene rubber was analyzed by infrared absorption spectrum analysis. The absorption band of the 1,4-cis structure is 740 cm⁻¹, the absorption band of the 1,4-trans structure is 967 cm⁻¹, and the absorption band of the 1,2-vinyl structure is 910 cm⁻¹, and the microstructure was calculated from each absorption intensity ratio.

### Method for Producing Butadiene Rubber

Examples of a method for producing butadiene rubber include a method in which butadiene is polymerized by using, for example, a catalyst such as a cobalt-based catalyst and/or a neodymium-based catalyst to synthesize the butadiene. The cobalt-based catalyst and the neodymium-based catalyst are not particularly limited. A compound containing cobalt can be used as a cobalt-based catalyst. A compound containing neodymium (Nd) can be used as a neodymium-based catalyst.

### Content of Butadiene Rubber

In the present invention, the content of the butadiene rubber is from 0 to 20% by mass with respect to the total amount of the rubber component.

The content of the butadiene rubber is preferably 5% by mass or more and less than 20% by mass, and more preferably from 10 to 15% by mass, with respect to the total amount of the rubber component, from the viewpoint of more excellent effects (in particular, wear resistance) of the present invention.

Rubber Other than Natural Rubber and Butadiene Rubber

In the present invention, the rubber component can further contain a rubber other than the natural rubber and the butadiene rubber.

Examples of a rubber other than the natural rubber and the butadiene rubber include a diene rubber (except for a natural rubber and butadiene rubber).

Examples of the diene rubber include isoprene rubber (IR), an aromatic vinyl-conjugated diene copolymer rubber (for example, styrene-butadiene rubber (SBR)), nitrile-butadiene rubber (NBR, acrylonitrile-butadiene rubber), butyl rubber (IIR), a halogenated butyl rubber (for example, Br-IIR or Cl-IIR), and chloroprene rubber (CR). In particular, styrene-butadiene rubber is preferable.

A method for producing a rubber other than the natural rubber and the butadiene rubber is not particularly limited. Examples thereof include known products.

### Carbon Black

The composition of the present invention contains carbon black.

### Nitrogen Adsorption Specific Surface Area of Carbon Black

The nitrogen adsorption specific surface area (N₂SA) of the carbon black is preferably from 115 to 160 m²/g and more preferably from 120 to 150 m²/g from the viewpoint of more excellent effects (in particular, wear resistance) of the present invention.

The nitrogen adsorption specific surface area of the carbon black is a value obtained by measuring a nitrogen adsorption amount on a surface of the carbon black based on JIS K 6217-2:2001 “Part 2: Determination of specific surface area-Nitrogen adsorption method-Single-point procedures”.

### Dibutyl Phthalate Oil Absorption Amount of Carbon Black

The dibutyl phthalate oil absorption amount (DBP oil absorption amount) of the carbon black is preferably from 115 to 140 mL/100 g and more preferably from 120 to 130 mL/100 g from the viewpoint of more excellent effects (in particular, wear resistance) of the present invention.

The dibutyl phthalate oil absorption amount of the carbon black is measured based on JIS K 6217-4:2008 “Carbon black for rubber-Fundamental characteristics—Part 4: Determination method of oil absorption amount”.

Examples of the carbon black includesuper abrasion furnace (SAF) carbon black and intermediate super abrasion furnace (ISAF) carbon black.

In particular, as the carbon black described above, SAF is preferable from the viewpoint of more excellent effects (in particular, wear resistance) of the present invention.

A method for producing carbon black is not particularly limited. Examples thereof include known products.

### Content of Carbon Black

In the present invention, the content of the carbon black is from 45 to 100 parts by mass with respect to 100 parts by mass of the rubber component.

The content of the carbon black is preferably more than 50 parts by mass (an amount exceeding 50 parts by mass) and 80 parts by mass or less, and more preferably more than 50 parts by mass and 70 parts by mass or less, with respect to 100 parts by mass of the rubber component, from the viewpoint of more excellent effects (in particular, a wear resistance) of the present invention.

### Sulfur

The sulfur included in the composition of the present invention is not particularly limited. Examples thereof include known products.

In the present invention, the content of the sulfur is from 0.50 to 2.00 parts by mass with respect to 100 parts by mass of the rubber component.

The content of the sulfur is preferably 0.50 parts by mass or more and less than 2.00 parts by mass, more preferably from 0.8 to 1.5 parts by mass, and still more preferably more than 1 part by mass and 1.5 parts by mass or less, with respect to 100 parts by mass of the rubber component, from the viewpoint of more excellent effects (in particular, wear resistance and/or impact resistance) of the present invention.

A method for producing sulfur is not particularly limited. Examples thereof include known methods.

### Vulcanization Accelerator

The vulcanization accelerator included in the composition of the present invention is not particularly limited as long as it can be used in a rubber composition. Examples of the vulcanization accelerator include a thiuram-based vulcanization accelerator, a sulfenamide-based vulcanization accelerator, a guanidine-based vulcanization accelerator, and a thiazole-based vulcanization accelerator.

Examples of the sulfenamide-based vulcanization accelerator include N-tert-butyl-2-benzothiazolyl sulfenamide (as a commercially available product, for example, Nocceler NS-P, available from Ouchi Shinko Chemical Industrial Co., Ltd.).

A method for producing the vulcanization accelerator is not particularly limited. Examples thereof include known methods.

In the present invention, the content of the vulcanization accelerator is 1.50 parts by mass or less with respect to 100 parts by mass of the rubber component.

The content of the vulcanization accelerator is preferably from 0.5 to 1.5 parts by mass and more preferably from 1.0 to 1.5 parts by mass with respect to 100 parts by mass of the rubber component from the viewpoint of more excellent effects (in particular, wear resistance) of the present invention.

### Vulcanization Accelerator/Sulfur

In the present invention, the mass ratio of the vulcanization accelerator to the sulfur (vulcanization accelerator/sulfur) is from 0.50 to 3.00.

The vulcanization accelerator/sulfur is preferably from 0.50 to 2.00 and more preferably from 0.50 to 1.50 from the viewpoint of more excellent effects (in particular, wear resistance) of the present invention.

### Additives

The composition of the present invention can further contain additives other than the respective components described above within a range which does not impair the effects and object of the present invention. Examples of additives include a white filler, an anti-aging agent such as an anti-aging agent 6C, zinc oxide, stearic acid, a processing aid, paraffin wax, aroma oil, a liquid polymer, a terpene resin, a thermosetting resin, a vulcanizing agent other than sulfur, a vulcanizing aid, and a vulcanization retardant.

The content of the additives can be appropriately selected.

### Method for Producing Composition of Present Invention

A method for producing the composition of the present invention is not particularly limited. For example, the respective components described above (except for a vulcanizing agent such as sulfur and a vulcanization accelerator) are mixed with a Banbury mixer and the like to obtain a mixture, a vulcanizing agent such as sulfur and a vulcanization accelerator are added to the obtained mixture as described above, and then the mixture is mixed with a kneading roll machine and the like, thereby producing the composition of the present invention.

In addition, conditions for vulcanization of the composition of the present invention are not particularly limited. The vulcanization can be performed, for example, by heating the composition of the present invention under the condition of a temperature of from 140 to 160° C. and pressurizing it.

The composition of the present invention can be used to form a conveyor belt.

The composition of the present invention has excellent wear resistance and impact resistance, and thus, a cured product formed using the composition of the present invention has excellent wear resistance and impact resistance.

As a preferred aspect, an upper surface cover rubber layer of the conveyor belt is formed using the composition of the present invention.

### Conveyor Belt

The conveyor belt of the present invention includes an upper surface cover rubber layer formed of the rubber composition for a conveyor belt of the present invention, a reinforcing layer, and a lower surface cover rubber layer.

The rubber composition forming the upper surface cover rubber layer is not particularly limited as long as it is the rubber composition for a conveyor belt of the present invention.

The upper surface cover rubber layer formed using the composition of the present invention has excellent wear resistance and impact resistance. The upper surface cover rubber layer has the excellent impact resistance as described above, such that an impact force by a conveyed product falling from a height onto the conveyor belt can be effectively absorbed and a breakage of the reinforcing layer due to the impact force (the conveyor belt is finally broken) can be prevented.

The upper surface cover rubber layer can be a single layer or a plurality of layers. This also applies to the reinforcing layer and the lower surface cover rubber layer.

The conveyor belt of the present invention will be described below using an attached drawing. However, the present invention is not limited by the attached drawing.

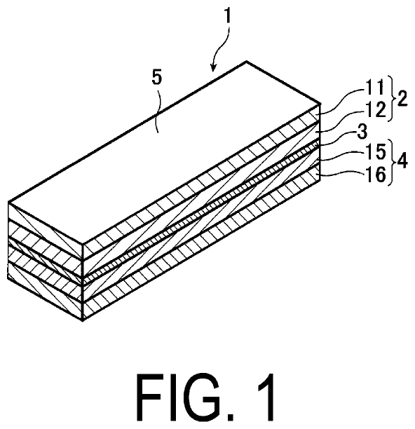

FIG. 1 is a cross-sectional perspective view schematically illustrating part of an example of a conveyor belt according to a preferred embodiment of the present invention.

In FIG. 1, a conveyor belt 1 has an upper surface cover rubber layer 2, a reinforcing layer 3, and a lower surface cover rubber layer 4, which are sequentially layered. The surface of the upper surface cover rubber layer 2 can be an object transportation conveying face 5.

In the conveyor belt of the present invention, the upper surface cover rubber layer may be formed using the composition of the present invention.

As illustrated in FIG. 1, in a case where the upper surface cover rubber layer has two or more layers, at least one of the two or more layers or all the layers can be formed using the composition of the present invention. In addition, at least the outermost layer is preferably formed using the composition of the present invention.

In FIG. 1, the upper surface cover rubber layer 2 has an outer layer 11 and an inner layer 12. The outer layer 11 and/or the inner layer 12 can be formed using the composition of the present invention and at least the outer layer 11 is preferably formed using the composition of the present invention. In a case where the outer layer 11 is formed using the composition of the present invention, the inner layer 12 can be a layer for causing the reinforcing layer 3 and the outer layer 11 to adhere to each other.

The rubber composition used in the lower surface cover rubber layer is not particularly limited. Examples of the rubber composition include the composition of the present invention.

In FIG. 1, the lower surface cover rubber layer 4 has an outer layer 16 and an inner layer 15. The outer layer 16 and the inner layer 15 may be formed by using the same or different rubber composition(s).

The reinforcing layer is not particularly limited, and substances typically used in conveyor belts can be suitably selected and used.

The reinforcing layer can include, for example, a core body and an adhesive rubber.

Examples of a material of the core body include fibers such as a polyester fiber, a polyamide fiber, and an aramid fiber; and a metal such as steel. The fiber can be used as a canvas. The canvas refers to plain woven fabric.

The adhesive rubber is not particularly limited. Examples thereof include known products.

The shape of the reinforcing layer is not particularly limited, and may be, for example, a sheet shape as illustrated in FIG. 1. In addition, reinforcing wires (for example, steel cords) may be embedded in parallel in the reinforcing layer.

Examples of the reinforcing layer having a sheet shape include a single layer canvas and a layered body having a plurality of canvas layers.

The thickness of the upper surface cover rubber layer is preferably from 3 to 25 mm.

The thickness of the lower surface cover rubber layer is preferably from 3 to 20 mm and more preferably from 5 to 15 mm.

Note that in a case where the upper surface cover rubber layer has two or more layers, the thickness of the upper surface cover rubber layer can be a total thickness of the two or more layers. This also applies to the thickness of the lower surface cover rubber layer.

A method for producing the conveyor belt of the present invention is not particularly limited. Examples thereof include known methods.

### EXAMPLES

The present invention is described below in detail using examples. However, the present invention is not limited to such examples.

### Production of Composition

The components shown in Table 1 below were used in compositions (part by mass) shown in the same table and mixed by an agitator to produce a composition. Specifically, first, components except for the sulfur and the vulcanization accelerator among the components listed in Table 1 were mixed with a Banbury mixer at 140° C., the sulfur and the vulcanization accelerator were added to the obtained mixture, and then the mixture was mixed with a kneading roll machine at 30° C., thereby producing a composition.

### Evaluation

The following evaluations were performed using the composition produced as described below. The results are shown in Table 1.

### Preparation of Vulcanized Rubber Sheet for Evaluation

The composition produced as described above was formed in a sheet shape, and the sheet-shaped composition was heated and vulcanized at 148° C. for 30 minutes to prepare a vulcanized rubber sheet.

### Wear Resistance: DIN Wear

DIN Wear Test

A DIN wear test was performed by using the vulcanized rubber sheet described above with a DIN wear testing machine based on JIS K 6264-2:2005 6.4.1 at 25° C. and a wear volume of the vulcanized rubber sheet (DIN wear B method) was measured.

Evaluation Standard of Wear Resistance

In a case where the wear volume measured as described above is less than 130 mm³, the wear resistance is excellent.

### Impact Resistance: M300

Tensile Test

From the vulcanized rubber sheet, a test piece was prepared by punching a rubber sheet piece into a JIS No. 3 dumbbell shape. A tensile test was performed based on JIS K 6251:2004 at room temperature and a tensile speed of 500 mm/min by using the test piece and a tensile stress (M300, unit: MPa) at the time of 300% elongation was measured.

Evaluation Standard of Impact Resistance

In a case where the M300 exceeds 11 MPa, the impact resistance is excellent.

TABLE 1

| | Comparative Example | | | | | Example | | | | | | | |
|---|---|---|---|---|---|---|---|---|---|---|---|---|---|
| | 1 | 2 | 3 | 4 | 5 | 1 | 2 | 3 | 4 | 5 | 6 | 7 | 8 |
| NR | 90 | 90 | 80 | 90 | 70 | 90 | 90 | 90 | 90 | 90 | 80 | 90 | 90 |
| BR1 | 10 | 10 | 20 | 10 | 30 | 10 | 10 | 10 | 10 | 10 | 20 | 10 | 10 |
| CB1 (N110) | | | | | | | | | | | | | 50 |
| CB2 (N234) | | | | | | | | | | | | 50 | |
| CB3 (N220) | 45 | 45 | 50 | 50 | 50 | 45 | 45 | 50 | 60 | 50 | 50 | | |
| Anti-aging agent 6C | 2.5 | 2.5 | 2.5 | 2.5 | 2.5 | 2.5 | 2.5 | 2.5 | 2.5 | 2.5 | 2.5 | 2.5 | 2.5 |
| Zinc oxide | 3 | 3 | 3 | 3 | 3 | 3 | 3 | 3 | 3 | 3 | 3 | 3 | 3 |
| Stearic acid | 2 | 2 | 2 | 2 | 2 | 2 | 2 | 2 | 2 | 2 | 2 | 2 | 2 |
| Paraffin wax | 1.5 | 1.5 | 1.5 | 1.5 | 1.5 | 1.5 | 1.5 | 1.5 | 1.5 | 1.5 | 1.5 | 1.5 | 1.5 |
| Aroma oil | 5 | 5 | 5 | 5 | 5 | 5 | 5 | 5 | 5 | 5 | 5 | 5 | 5 |
| Vulcanization accelerator NS | 2.0 | 3.0 | 0.54 | 1.3 | 1.0 | 1.0 | 1.3 | 1.0 | 1.0 | 1.0 | 1.0 | 1.0 | 1.0 |
| Sulfur | 1.0 | 0.3 | 2.0 | 3.0 | 2.0 | 2.0 | 1.0 | 2.0 | 2.0 | 1.0 | 2.0 | 2.0 | 2.0 |
| Vulcanization accelerator | 2.0 | 10.0 | 0.27 | 0.4 | 0.5 | 0.5 | 1.3 | 0.5 | 0.5 | 1.0 | 0.5 | 0.5 | 0.5 |
| NS/sulfur (mass ratio) | | | | | | | | | | | | | |
| Wear resistance (DIM, mm³) | 155 | 174 | 102 | 147 | 73 | 124 | 126 | 121 | 118 | 122 | 97 | 116 | 102 |
| Impact resistance (M300, | 10.5 | 10.3 | 11.0 | 14.4 | 10.8 | 11.2 | 11.3 | 12.4 | 15.2 | 12.1 | 12.3 | 13.2 | 11.7 |
| MPa) | | | | | | | | | | | | | |

Details of the components described in Table 1 are as follows.
NR: Natural rubber; (RSS #3)
BR1: butadiene rubber, weight average molecular weight (Mw) of 500000, (trade name, Nipol BR1220, available from Zeon Corporation) microstructure: 1,4-cis structure of 98.0%, 1,4-trans structure of 1.0%, and 1,2-vinyl structure of 1.0%
CB1 (N110): carbon black, nitrogen adsorption specific surface area of 144 m²/g, dibutyl phthalate oil absorption amount of 115 mL/100 g (SHOW-BLACK N110, SAF grade, available from Cabot Japan K.K.)
CB2 (N234): carbon black, nitrogen adsorption specific surface area of 123 m²/g, dibutyl phthalate oil absorption amount of 123 mL/100 g (trade name, SHOW-BLACK N234, ISAF-HS grade, available from Cabot Japan K.K.)
CB3 (N220): carbon black, nitrogen adsorption specific surface area of 111 m²/g, dibutyl phthalate oil absorption amount of 115 mL/100 g (trade name, SHOW-BLACK N220, ISAF-LS grade, available from Cabot Japan K.K.)
Anti-aging agent 6C: Nocrac 6C (available from Ouchi Shinko Chemical Industrial Co., Ltd.)
Zinc oxide: Zinc oxide III (available from Seido Chemical Industry Co., Ltd.)
Stearic acid: Stearic acid YR (available from NOF corporation)
Paraffin wax: OZOACE-0015 (available from Nippon Seiro Co., Ltd.)
Aroma oil: A-OMIX (available from Sankyo Yuka Kogyo K.K.)
Vulcanization accelerator NS: N-tert-butyl-2-benzothiazolyl sulfenamide, Nocceler NS-P, (available from Ouchi Shinko Chemical Industrial Co., Ltd.)
Sulfur: fine powder sulfur (available from Hosoi Chemical Industry Co., Ltd.)

As is clear from the results shown in Table 1, the wear resistance and the impact resistance were poor in Comparative Examples 1 and 2 in which the content of the vulcanization accelerator is outside the predetermined range.

The impact resistance was poor in Comparative Example 3 in which the mass ratio of vulcanization accelerator/sulfur is outside the predetermined range.

The wear resistance was poor in Comparative Example 4 in which the content of the sulfur and the mass ratio of vulcanization accelerator/sulfur are outside the predetermined range.

The impact resistance was poor in Comparative Example 5 in which the contents of the natural rubber and the butadiene rubber are outside the predetermined range.

Meanwhile, the composition of the present invention was excellent in the wear resistance and the impact resistance.

### REFERENCE SIGNS LIST

1 Conveyor belt
2 Upper surface cover rubber layer
3 Reinforcing layer
4 Lower surface cover rubber layer
5 Object transportation conveying face
11, 16 Outer layer
12, 15 Inner layer

1. A rubber composition for a conveyor belt comprising:
a rubber component containing from 80 to 100% by mass of a natural rubber and from 0 to 20% by mass of a butadiene rubber;
carbon black;
sulfur; and
a vulcanization accelerator,
wherein a content of the carbon black is from 45 to 100 parts by mass with respect to 100 parts by mass of the rubber component;
a content of the sulfur is from 0.50 to 2.00 parts by mass with respect to 100 parts by mass of the rubber component;
a content of the vulcanization accelerator is 1.50 parts by mass or less with respect to 100 parts by mass of the rubber component; and
a mass ratio of the vulcanization accelerator to the sulfur is from 0.50 to 3.00.

2. The rubber composition for a conveyor belt according to claim 1,
wherein a nitrogen adsorption specific surface area of the carbon black is from 115 to 160 m²/g, and
a dibutyl phthalate oil absorption amount of the carbon black is from 115 to 140 mL/100 g.

3. The rubber composition for a conveyor belt according to claim 1,
wherein the rubber component contains a natural rubber and a butadiene rubber,
a content of the natural rubber is more than 80% by mass and 95% by mass or less with respect to a total amount of the rubber component, and
a content of the butadiene rubber is 5% by mass or more and less than 20% by mass with respect to the total amount of the rubber component.

4. The rubber composition for a conveyor belt according to claim 1, wherein a content of the carbon black is more than 50 parts by mass and 80 parts by mass or less with respect to 100 parts by mass of the rubber component.

5. The rubber composition for a conveyor belt according to claim 1, wherein a content of the sulfur is 0.50 parts by mass or more and less than 2.00 parts by mass with respect to 100 parts by mass of the rubber component.

6. A conveyor belt comprising:
an upper surface cover rubber layer formed of the rubber composition for a conveyor belt described in claim 1;
a reinforcing layer; and
a lower surface cover rubber layer.

7. The rubber composition for a conveyor belt according to claim 2,
wherein the rubber component contains a natural rubber and a butadiene rubber,
a content of the natural rubber is more than 80% by mass and 95% by mass or less with respect to a total amount of the rubber component, and
a content of the butadiene rubber is 5% by mass or more and less than 20% by mass with respect to the total amount of the rubber component.

8. The rubber composition for a conveyor belt according to claim 2, wherein a content of the carbon black is more than 50 parts by mass and 80 parts by mass or less with respect to 100 parts by mass of the rubber component.

9. The rubber composition for a conveyor belt according to claim 2, wherein a content of the sulfur is 0.50 parts by mass or more and less than 2.00 parts by mass with respect to 100 parts by mass of the rubber component.

10. The rubber composition for a conveyor belt according to claim 3, wherein a content of the carbon black is more than 50 parts by mass and 80 parts by mass or less with respect to 100 parts by mass of the rubber component.

11. The rubber composition for a conveyor belt according to claim 3, wherein a content of the sulfur is 0.50 parts by mass or more and less than 2.00 parts by mass with respect to 100 parts by mass of the rubber component.

12. The rubber composition for a conveyor belt according to claim 4, wherein a content of the sulfur is 0.50 parts by mass or more and less than 2.00 parts by mass with respect to 100 parts by mass of the rubber component.
